(19) United States
(12) Patent Application Publication
(10) Pub. No.: US 2026/0282106 A1
(43) Pub. Date: Sep. 17, 2026

(54) FREQUENCY DIVISION MULTIPLEXING OF RANDOM ACCESS CHANNEL OCCASIONS

(71) Applicant: Samsung Electronics Co., Ltd., Suwon-si (KR)

(72) Inventors: Anil Agiwal, McKinney, TX (US); Kyeongin Jeong, Frisco, TX (US)

(21) Appl. No.: 19/551,467

(22) Filed: Feb. 26, 2026

Related U.S. Application Data
(60) Provisional application No. 63/770,094, filed on Mar. 11, 2025.

(51) Int. Cl. H04W 74/0833; H04L 27/26

(52) U.S. Cl. CPC H04W 74/0833; H04L 27/26414

(57) ABSTRACT

A method of operating a user equipment (UE) includes receiving a random access (RA) configuration including one or more parameters configuring a first set of random access channel (RACH) occasions (ROs) and a second set of ROs. The method also includes determining whether frequency division multiplexed (FDMed) ROs in the second set of ROs are FDMed with one or more ROs in the first set of ROs. When FDMed ROs in the second set of ROs are FDMed with one or more ROs in the first set of ROs, the FDMed ROs in the second set of ROs FDMed with the one or more ROs in the first set of ROs are sequentially indexed in increasing order of frequency with an index starting from a value of a parameter in the RA configuration indicating a number of ROs FDMed in one time instance in the first set of ROs.

### CROSS-REFERENCE TO RELATED APPLICATION(S) AND CLAIM OF PRIORITY

This application claims priority under 35 U.S.C. § 119(e) to U.S. Provisional Patent Application No. 63/770,094 filed on Mar. 11, 2025. The above-identified provisional patent application is hereby incorporated by reference in its entirety.

### TECHNICAL FIELD

This disclosure relates generally to wireless networks. More specifically, this disclosure relates to frequency division multiplexing (FDMing) of random access channel (RACH) occasions (ROs).

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods of FDMing of ROs.

In one embodiment, a method of operating a user equipment (UE) is provided. The method includes receiving a random access (RA) configuration including one or more parameters configuring a first set of random access channel (RACH) occasions (ROs) and a second set of ROs. The method also includes determining whether frequency division multiplexed (FDMed) ROs in the second set of ROs are FDMed with one or more ROs in the first set of ROs. When FDMed ROs in the second set of ROs are FDMed with one or more ROs in the first set of ROs, the FDMed ROs in the second set of ROs FDMed with the one or more ROs in the first set of ROs are sequentially indexed in increasing order of frequency with an index starting from a value of a parameter in the RA configuration indicating a number of ROs FDMed in one time instance in the first set of ROs.

In another embodiment, a method of operating a BS is provided. The method includes transmitting an RA configuration including one or more parameters configuring a first set of ROs and a second set of ROs. The method also includes determining whether FDMed ROs in the second set of ROs are FDMed with one or more ROs in the first set of ROs. When FDMed ROs in the second set of ROs are FDMed with one or more ROs in the first set of ROs, the FDMed ROs in the second set of ROs FDMed with the one or more ROs in the first set of ROs are sequentially indexed in increasing order of frequency with an index starting from a value of a parameter in the RA configuration indicating a number of ROs FDMed in one time instance in the first set of ROs.

In yet another embodiment, an electronic device is provided. The electronic device includes at least one processor including processing circuitry, and memory storing instructions. The instructions, when executed by the at least one processor individually or collectively, cause the electronic device to (i) receive an RA configuration including one or more parameters configuring a first set of ROs and a second set of ROs, and (ii) determine whether FDMed ROs in the second set of ROs are FDMed with one or more ROs in the first set of ROs. When FDMed ROs in the second set of ROs are FDMed with one or more ROs in the first set of ROs, the FDMed ROs in the second set of ROs FDMed with the one or more ROs in the first set of ROs are sequentially indexed in increasing order of frequency with an index starting from a value of a parameter in the RA configuration indicating a number of ROs FDMed in one time instance in the first set of ROs.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example of PRACH transmission occasions according to embodiments of the present disclosure;

FIG. 5 illustrates an example of indexing PRACH transmission occasions of additional RACH occasions in a random access resource configuration according to embodiments of the present disclosure;

FIG. 6 illustrates another example of indexing PRACH transmission occasions of additional RACH occasions in a random access resource configuration according to embodiments of the present disclosure;

FIG. 7 illustrates an example method of FDMing of ROs according to embodiments of the present disclosure; and

FIG. 8 illustrates another example method of FDMing of ROs according to embodiments of the present disclosure.

### DETAILED DESCRIPTION

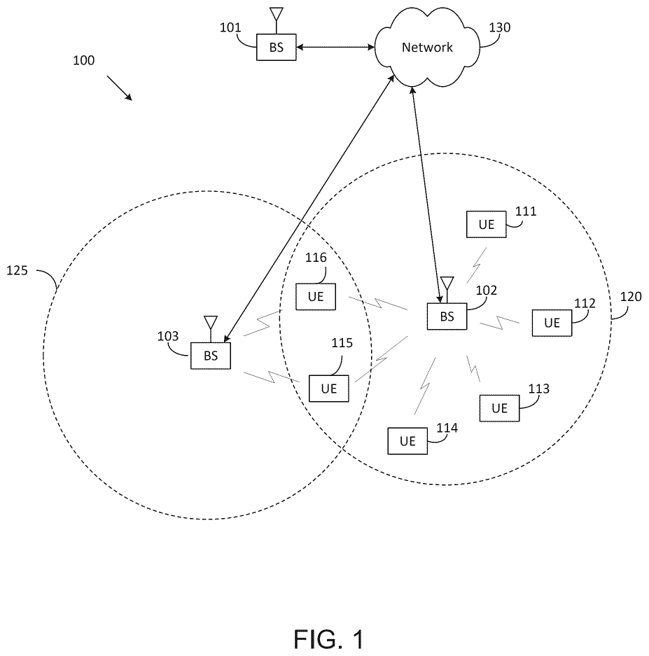

FIGS. 1 through 8, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for FDMing of ROs. In certain embodiments, one or more of the gNBs 101-103 includes circuitry, programing, or a combination thereof, to support FDMing of ROs in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

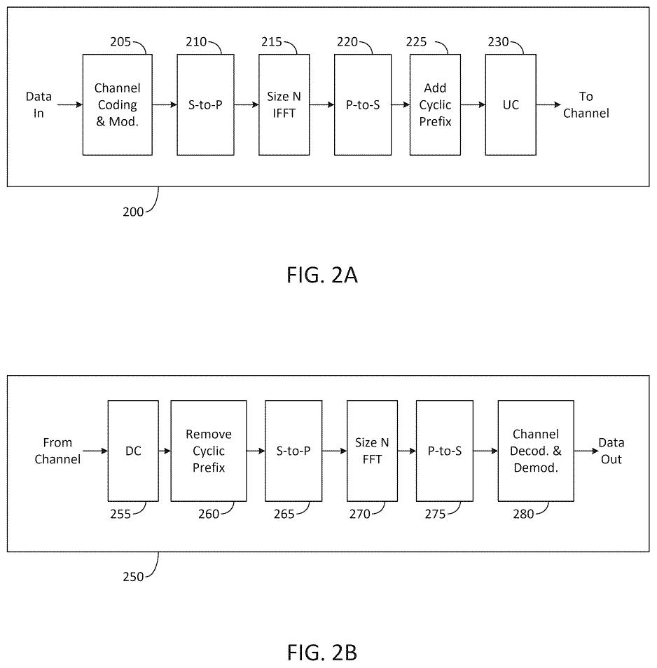

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support FDMing of ROs as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

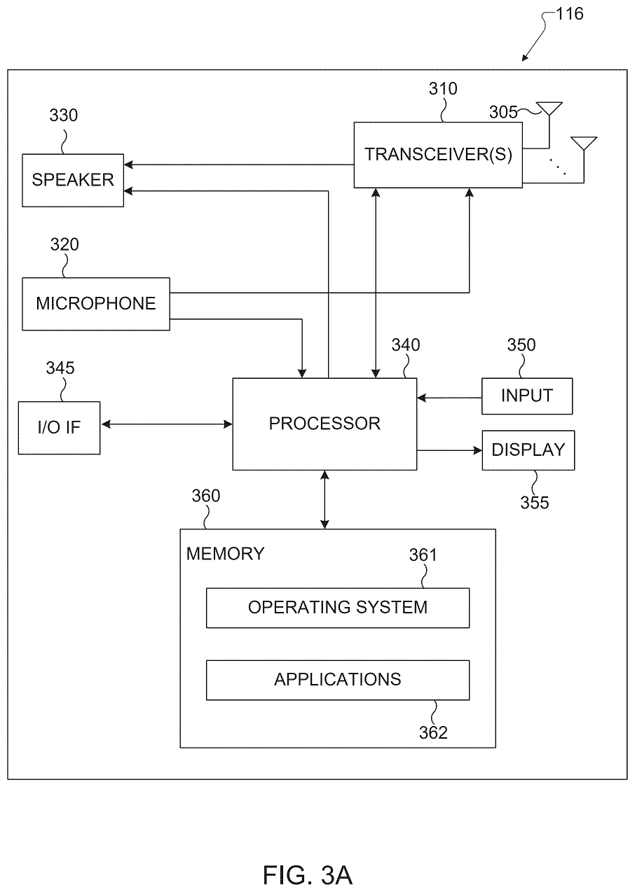

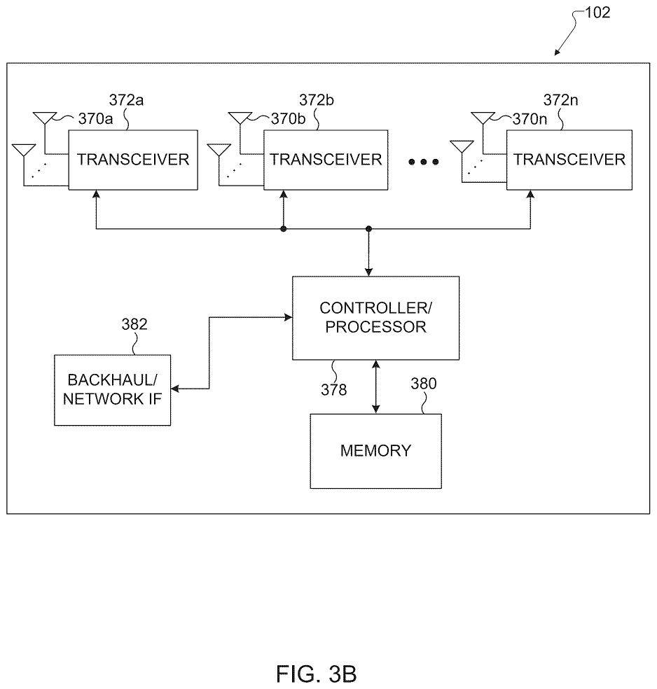

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an 0 (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for FDMing of ROs as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the LE 116 can use the input 350 to enter data into the LE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support FDMing of ROs as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G, 6G) supports not only lower frequency bands but also higher frequency (mmWave) bands (e.g., 10 GHz to 100 GHz bands), so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, analog beam forming, and large scale antenna techniques are being considered in the design of the next generation wireless communication system. In addition, the next generation wireless communication system is expected to address different use cases having quite different requirements in terms of data rate, latency, reliability, mobility etc. However, it is expected that the design of the air-interface of the next generation wireless communication system would be flexible enough to serve UEs having quite different capabilities depending on the use case and market segment the TIE caters service to the end customer. A few example use cases the next generation wireless communication system wireless system is expected to address is enhanced Mobile Broadband (eMBB), massive Machine Type Communication (m-MTC), ultra-reliable low latency communication (URLL), etc. eMBB requirements like tens of Gbps data rate, low latency, high mobility, etc. address the market segment representing conventional wireless broadband subscribers needing internet connectivity everywhere, all the time and on the go. m-MTC requirements like very high connection density, infrequent data transmission, very long battery life, low mobility, etc. address the market segment representing Internet of Things (IoT)/Internet of Everything (IoE) envisioning connectivity of billions of devices. URLL requirements like very low latency, very high reliability and variable mobility, address the market segment representing industrial automation applications, and vehicle-to-vehicle/vehicle-to-infrastructure communication, which is foreseen as one of the enablers for autonomous cars.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well as dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-InactivityTimer, by RRC signaling, or by the medium access control (MAC) entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured).

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of s (SIBs) where: the MIB is transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and positioning SIBs (posSIBs) are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window, and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RRCReconfiguration message). Nevertheless, the UE shall acquire the MIB of the PSCell to get system frame number (SFN) timing of the SCG (which may be different from MCG). Upon a change of relevant SI for the SCell, the network releases and adds the concerned SCell. For the PSCell, the required SI can only be changed with Reconfiguration with Sync.

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below: (y*(number of slots in a radio frame)+x−Monitoring-offset-PDCCH-slot) mod (Monitoring-periodicity-PDCCH-slot)=0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots depends on radio frame for each supported SCS is pre-defined in NR. Each CORESET configuration is associated with a list of Transmission configuration indicator (TCI) states. One DL reference signal (RS) identification (ID) (SSB or channel state information [CSI] RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is quasi co-located [QCLed] with the SSB/CSI RS of the TCI state) used by the gNB for transmission of the PDCCH in the PDCCH monitoring occasions of a search space.

In the next generation wireless communication system (e.g., 5G, beyond 5G, 6G), random access (RA) is supported. RA is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by a non-synchronized UE in an RRC CONNECTED state or for a SIB1 request or for an SI request. Several types of random-access procedure are supported such as contention based random access, contention free random access and each of these can be one of 2 step or 4 step random access.

In contention based random access (CBRA), also referred as 4 step CBRA, the UE first transmits a Random Access preamble (also referred to as Msg1) and then waits for a Random access response (RAR) in the RAR window. The RAR is also referred to as Msg2. A next generation node B (gNB) transmits the RAR on the physical downlink shared channel (PDSCH). A PDCCH scheduling the PDSCH carrying the RAR is addressed to a RA-radio network temporary identifier (RA-RNTI). The RA-RNTI identifies the time-frequency resource (also referred to as a physical RA channel [PRACH] occasion or PRACH transmission [TX] occasion or RA channel [RACH] occasion) in which the RA preamble was detected by the gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where the UE has transmitted the Msg1, (i.e., RA preamble); 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for a normal UL [NUL] carrier and 1 for a supplementary UL [SUL] carrier. Several RARs for various Random-access preambles detected by the gNB can be multiplexed in the same RAR media access control (MAC) protocol data unit (PDU) by the gNB. A RAR in MAC PDU corresponds to the UE's RA preamble transmission if the RAR includes an RA preamble identifier (RAPID) of the RA preamble transmitted by the UE. If the RAR corresponding to its RA preamble transmission is not received during the RAR window and the UE has not yet transmitted the RA preamble for a configurable (configured by the gNB in a RACH configuration) number of times, the UE goes back to the first step (i.e., select a random access resource [preamble/RACH occasion]) and transmits the RA preamble. A backoff may be applied before going back to first step.

If the RAR corresponding to its RA preamble transmission is received, the UE transmits a message 3 (Msg3) in the UL grant received in the RAR. The Msg3 includes a message such as an RRC connection request, RRC connection re-establishment request, RRC handover confirm, scheduling request, SI request etc. It may include the UE identity (i.e., cell-radio network temporary identifier [C-RNTI] or system architecture evolution [SAE]-temporary mobile subscriber identity [S-TMSI] or a random number). After transmitting the Msg3, the UE starts a contention resolution timer. While the contention resolution timer is running, if UE receives a physical downlink control channel (PDCCH) addressed to the C-RNTI included in the Msg3, contention resolution is considered successful, the contention resolution timer is stopped, and the RA procedure is completed. While the contention resolution timer is running, if the UE receives a contention resolution MAC control element (CE) including the UE's contention resolution identity (first X bits of common control channel [CCCH] service data unit [SDU] transmitted in the Msg3), contention resolution is considered successful, the contention resolution timer is stopped, and the RA procedure is completed. If the contention resolution timer expires and the UE has not yet transmitted the RA preamble for a configurable number of times, the UE goes back to the first step (i.e., select random access resource [preamble/RACH occasion]) and transmits the RA preamble. A backoff may be applied before going back to first step.

Contention free random access (CFRA), also referred to as legacy CFRA or 4 step CFRA, is used for scenarios such as handover where low latency is required, timing advance establishment for secondary cell (Scell), etc. An evolved node B (eNB) assigns to the UE a dedicated Random access preamble. The UE transmits the dedicated RA preamble. The eNB transmits the RAR on a PDSCH addressed to a RA-RNTI. The RAR conveys an RA preamble identifier and timing alignment information. The RAR may also include an UL grant. The RAR is transmitted in RAR window similar to contention-based RA (CBRA) procedure. The CFRA is considered successfully completed after receiving the RAR including the RA preamble identifier (RAPID) of the RA preamble transmitted by the UE. In case the RA is initiated for beam failure recovery, the CFRA is considered successfully completed if a PDCCH addressed to a C-RNTI is received in the search space for beam failure recovery. If the RAR window expires and the RA is not successfully completed and the UE has not yet transmitted the RA preamble for a configurable (configured by the gNB in a RACH configuration) number of times, the UE retransmits the RA preamble.

Network energy saving is of great importance for environmental sustainability, to reduce environmental impact (greenhouse gas emissions), and for operational cost savings. As wireless communication systems are becoming pervasive across industries and geographical areas, handling more advanced services and applications requiring very high data rates (e.g., XR), networks are becoming denser, use more antennas, use larger bandwidths, and use more frequency bands. Novel solutions to improve network energy savings are desirable to control the environmental impact of wireless communications systems.

Energy consumption has become a key part of the operators' OPEX. The energy cost on mobile networks accounts for ~23% of the total operator cost. Most of the energy consumption comes from the radio access network, and in particular from the Active Antenna Unit (AAU), with data centers and fiber transport accounting for a smaller share. The power consumption of a radio access can be split into two parts: the dynamic part which is only consumed when data transmission/reception is ongoing, and the static part which is consumed all the time to maintain the necessary operation of the radio access devices, even when data transmission/reception is not on-going.

Some existing wireless networks signal random access configurations per BWP. In such networks, each BWP may include one or more random access configurations, where each random access configuration is mapped to a feature or feature combination, or not mapped to any feature. Examples of such features include small data transmission (SDT), reduced capability (RedCap), enhanced RedCap (eRedcap), slicing, Msg3 repetition, Msg1 repetition, etc.

A random access configuration can include one or more contention based random access preambles.

A random access configuration can also include prach-ConfigurationIndex which indicates the available set of PRACH occasions in the time domain for the transmission of the Random Access Preamble. The number of PRACH occasions in a PRACH configuration period is pre-defined for each PRACH configuration index. A PRACH configuration period for each PRACH configuration index is also pre-defined. A pre-defined PRACH configuration table lists a number of configurations, wherein each configuration indicates a number of PRACH occasions in a PRACH configuration period, the PRACH configuration period, and the location of PRACH occasions in the PRACH configuration period. A PRACH configuration index is an index to an entry in this PRACH configuration table.

A random access configuration can also include a msg1-FrequencyStart and msg1-FDM which indicates the PRACH transmission occasions in the frequency domain. msg1-FrequencyStart is the offset of lowest PRACH transmission occasion in the frequency domain with respective to PRB 0. msg1-FDM indicates the number of PRACH transmission occasions frequency division multiplexed (FDMed) in one time instance. The PRACH frequency resources (i.e., PRACH transmission occasions in the frequency domain) n_RA ∈{0,1, . . . ,M−1}, where M equals the parameter msg1-FDM, are numbered in increasing order, starting from the lowest frequency.

Network energy savings can be enhanced by utilizing PRACH adaptation. For PRACH adaptation, in addition to existing PRACH transmission occasions, additional PRACH transmission occasions/resources can be configured in a random access configuration. Additional PRACH transmission occasions/resources for a random access configuration can then be signaled by including at least one of a msg1-Frequency Start, msg1-FDM, or prach-ConfigurationIndex parameter separately for the additional PRACH transmission occasions/resources. These additional PRACH transmission occasions/resources can be dynamically activated/deactivated by the network, and a UE can consider them for random access if activated.

A random access configuration can include two sets of parameters {msg1-FrequencyStart, msg1-FDM}. The first set in the random access configuration is the existing configuration to signal FDMed PRACH transmission occasions. The second set in the random access configuration is a new/additional configuration to signal FDMed PRACH transmission occasions for additional RACH occasions. The first and second sets of parameters {msg1-FrequencyStart, msg1-FDM} can be received in a RACH-ConfigCommon IE or RACH-ConfigGeneric of a random access resource configuration.

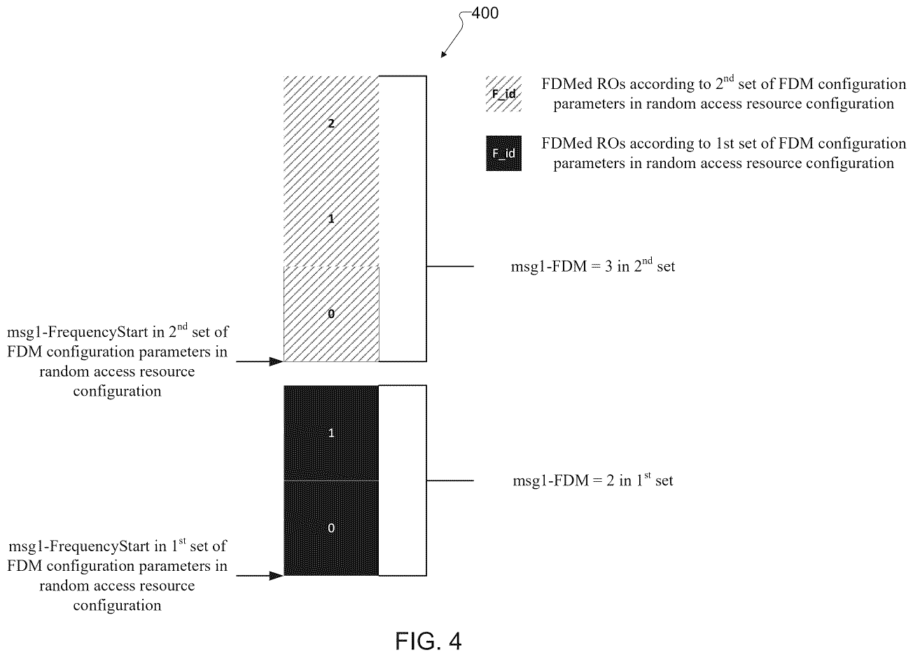

For example, consider that that the parameter msg1-FDM in a first set is M1 and msg1-FDM in a second set is M2. The M1 PRACH transmission occasions in the frequency domain are numbered/indexed from 0 to M1−1. The M2 PRACH transmission occasions in the frequency domain are numbered/indexed from 0 to M2−1. This index/number of FDMed PRACH transmission occasions is also referred to as f_id. As a result, several PRACH transmission occasions in the frequency domain will have same number/index (i.e., f_id), similar as shown in FIG. 4.

FIG. 4 illustrates an example of PRACH transmission occasions 400 according to embodiments of the present disclosure. The embodiment of PRACH transmission occasions of FIG. 4 is for illustration only. Different embodiments of PRACH transmission occasions could be used without departing from the scope of this disclosure.

In the example of FIG. 4, the PRACH transmission occasions 400 are PRACH transmission occasions in the frequency domain based on a first and second set of parameters {msg1-Frequency Start, msg1-FDM} in a random access configuration. As shown in FIG. 4, several RACH occasions in the frequency domain have the same f_id. The consequence of this is that even if two UEs select different PRACH transmission occasions in the frequency domain, the RA-RNTI will be same, resulting in each UE receiving a RAR incorrectly.

Although FIG. 4 illustrates one example of PRACH transmission occasions 400, various changes may be made to FIG. 4. For example, various changes to the number of PRACH transmission occasions could be made, etc. according to particular needs.

As noted above, a random access configuration that includes two sets of parameters{msg1-FrequencyStart, msg1-FDM} results in several PRACH transmission occasions in the frequency domain having the same number/index. Various embodiments of the present disclosure provide mechanisms to prevent PRACH transmission occasions in the frequency domain having the same number/index in a random access configuration that includes two sets of parameters {msg1-Frequency Start, msg1-FDM}.

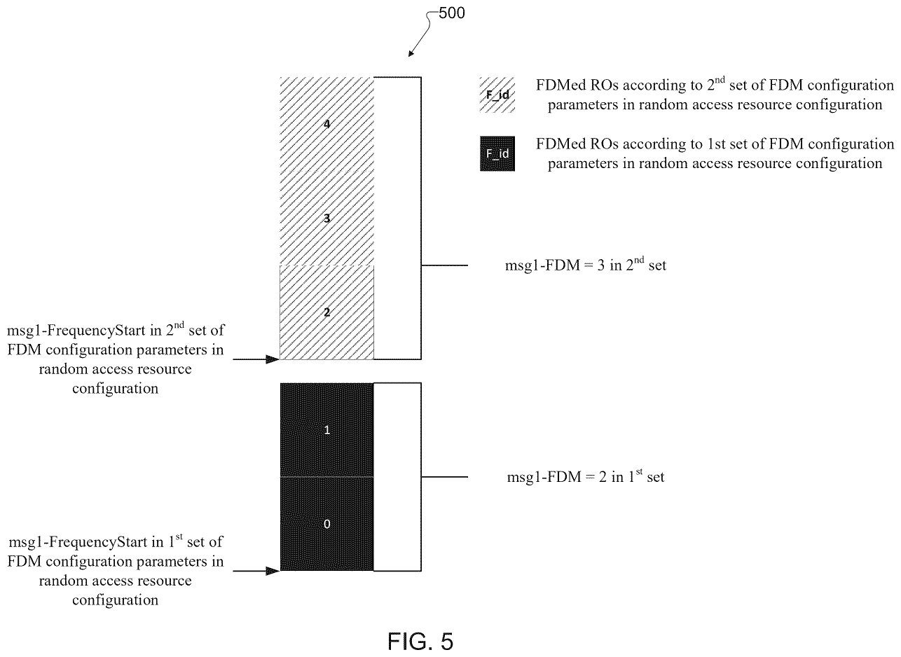

FIG. 5 illustrates an example of indexing PRACH transmission occasions of additional RACH occasions 500 in a random access resource configuration according to embodiments of the present disclosure. The embodiment of indexing PRACH transmission occasions of additional RACH occasions of FIG. 5 is for illustration only. Different embodiments of indexing PRACH transmission occasions of additional RACH occasions could be used without departing from the scope of this disclosure.

In some embodiments, a UE (such as UE 116 of FIG. 1) may receive a random access resource configuration from a gNB (such as gNB 102 of FIG. 1) in system information or RRC message. The random access resource configuration can include a 1^{st} and/or 2^{nd} set of parameters {msg1-Frequency Start, msg1-FDM} as shown in FIG. 5. The 1st set of parameters {msg1-Frequency Start, msg1-FDM} indicates FDMed PRACH transmission occasions for a 1^{st} set of PRACH resources. These PRACH resources may not be dynamically activated/deactivated. The 2^{nd} set of parameters {msg1-Frequency Start, msg1-FDM} indicates FDMed PRACH transmission occasions for additional PRACH resources (a 2^{nd} set of PRACH resources) which are dynamically activated/deactivated. In some embodiments, the 1^{st} set of PRACH resources in the time domain can be indicated by a 1^{st} PRACH configuration index. In some embodiments, the 2^{nd} set of PRACH resources in the time domain can be indicated by a 2^{nd} PRACH configuration index, if configured. Otherwise, the 2^{nd} set of PRACH resources in the time domain can be indicated by the 1^{st} PRACH configuration index in the random access resource configuration.

In some embodiments, if a 1^{st} set of parameters {msg1-Frequency Start, msg1-FDM} is received in a random access resource configuration:
The PRACH frequency resources (i.e., PRACH transmission occasions in the frequency domain) configured by a 2^{nd} set of parameters {msg1-Frequency Start, msg1-FDM} ∈{M,M+1, . . . ,M+N−1} (where M equals the parameter msg1-FDM in the 1^{st} set of parameters {msg1-FrequencyStart, msg1-FDM}, and N equals the parameter msg1-FDM in the 2^{nd} set of parameters {msg1-Frequency Start, msg1-FDM}) are numbered/indexed in increasing order, starting from the lowest frequency (indicated by msg1-Frequency Start in the 2^{nd} set). Alternatively, in some embodiments, M can be a start index signaled/received in a random access resource configuration. This index/number of FDMed PRACH transmission occasions is also referred to as f_id.
The PRACH frequency resources (i.e., PRACH transmission occasions in the frequency domain) configured by the 1^{st} set of parameters {msg1-Frequency Start, msg1-FDM} ∈{0,1, . . . ,M−1} (where M equals the parameter msg1-FDM in the 1^{st} set of {msg1-FrequencyStart, msg1-FDM}) are numbered in increasing order, starting from the lowest frequency (indicated by msg1-Frequency Start in the 1^{st} set). This index/number of FDMed PRACH transmission occasions is also referred to as f_id.

Otherwise, if a 1^{st} set of parameters {msg1-Frequency Start, msg1-FDM} is not received in the random access resource configuration, the PRACH frequency resources (i.e., PRACH transmission occasions in the frequency domain) configured by a 2^{nd} set of parameters {msg1-Frequency Start, msg1-FDM} ∈{0,1, . . . ,M−1} (where M equals the parameter msg1-FDM in the 2^{nd} set of {msg1-Frequency Start, msg1-FDM}) are numbered in increasing order, starting from the lowest frequency (indicated by msg1-FrequencyStart in the 2^{nd} set). This index/number of FDMed PRACH transmission occasions is also referred to as f_id.

Although FIG. 5 illustrates one example of indexing PRACH transmission occasions of additional RACH occasions 500, various changes may be made to FIG. 5. For example, various changes to number of PRACH transmission occasions could be made, etc. according to particular needs.

In some embodiments, if a 1^{st} set of parameters {msg1-Frequency Start, msg1-FDM} is received in a random access resource configuration and ROs in the 1^{st} set of PRACH resources and 2^{nd} set of PRACH resources overlap in the time domain (e.g., the PRACH configuration index used to determine the 2^{nd} set of PRACH resources in the time domain is the same as the PRACH configuration index used to determine 1^{st} set of PRACH resources in the time domain):
The PRACH frequency resources (i.e., PRACH transmission occasions in the frequency domain) configured by the 2^{nd} set of parameters {msg1-FrequencyStart, msg1-FDM} ∈{M,M+1, . . . ,M+N−1} (where M equals the parameter msg1-FDM in the 1^{st} set of {msg1-FrequencyStart, msg1-FDM}, and N equals the parameter msg1-FDM in the 2^{nd} set of {msg1-Frequency Start, msg1-FDM}), are numbered in increasing order, starting from the lowest frequency (indicated by msg1-FrequencyStart in the 2^{nd} set). In an alternate embodiment, M can be a start index signalled/received in a random-access resource configuration. This index/number of FDMed PRACH transmission occasions is also referred to as f_id.
The PRACH frequency resources (i.e., PRACH transmission occasions in the frequency domain) configured by the 1^{st} set of parameters {msg1-FrequencyStart, msg1-FDM} ∈{0,1, . . . ,M−1} (where M equals the parameter msg1-FDM in 1^{st} set of {msg1-FrequencyStart, msg1-FDM}) are numbered in increasing order, starting from the lowest frequency (indicated by msg1-FrequencyStart in the 1^{st} set). This index/number of FDMed PRACH transmission occasions is also referred to as f_id.

Otherwise, the PRACH frequency resources (i.e., PRACH transmission occasions in the frequency domain) configured by the 2^{nd} set of parameters {msg1-FrequencyStart, msg1-FDM} ∈{0,1, . . . ,M−1}, where M equals the parameter msg1-FDM in 2^{nd} set of {msg1-FrequencyStart, msg1-FDM}, are numbered in increasing order, starting from the lowest frequency (indicated by msg1-FrequencyStart in the 2^{nd} set). This index/number of FDMed PRACH transmission occasions is also referred to as f_id.

Alternatively, in some embodiments, if a 1^{st} set of parameters {msg1-FrequencyStart, msg1-FDM} is received in a random access resource configuration and ROs in the 1^{st} set of PRACH resources and 2^{nd} set of PRACH resources are FDMed with each other:
The PRACH frequency resources (i.e., PRACH transmission occasions in the frequency domain) configured by the 2^{nd} set of parameters {msg1-FrequencyStart, msg1-FDM} ∈{M,M+1, . . . ,M+N−1} (where M equals the parameter msg1-FDM in the 1^{st} set of {msg1-FrequencyStart, msg1-FDM}, and N equals the parameter msg1-FDM in the 2^{nd} set of {msg1-Frequency Start, msg1-FDM}) are numbered in increasing order, starting from the lowest frequency (indicated by msg1-FrequencyStart in the 2^{nd} set). Alternatively, in some embodiments, M can be a start index signalled/received in the random-access resource configuration. This index/number of FDMed PRACH transmission occasions is also referred to as f_id.
The PRACH frequency resources (i.e., PRACH transmission occasions in the frequency domain) configured by the 1^{st} set of parameters {msg1-FrequencyStart, msg1-FDM} ∈{0,1, . . . ,M−1} (where M equals the parameter msg1-FDM in 1^{st} set of {msg1-FrequencyStart, msg1-FDM}) are numbered in increasing order, starting from the lowest frequency (indicated by msg1-FrequencyStart in the 1^{st} set). This index/number of FDMed PRACH transmission occasions is also referred to as f_id.

Otherwise, The PRACH frequency resources (i.e., PRACH transmission occasions in the frequency domain) configured by the 2^{nd} set of parameters {msg1-FrequencyStart, msg1-FDM} ∈{0,1, . . . ,M−1} (where M equals the parameter msg1-FDM in 2^{nd} set of {msg1-FrequencyStart, msg1-FDM}) are numbered in increasing order, starting from the lowest frequency (indicated by msg1-FrequencyStart in the 2^{nd} set). This index/number of FDMed PRACH transmission occasions is also referred to as f_id.

In some embodiments, if a 2^{nd} set of parameters {msg1-FrequencyStart, msg1-FDM} is received in a random access resource configuration, the PRACH frequency resources (i.e., PRACH transmission occasions in the frequency domain) configured by the 2^{nd} set of parameters {msg1-FrequencyStart, msg1-FDM} ∈{M,M+1, . . . ,M+N−1} (where M equals the start index signaled/received in random access resource configuration, and N equals the parameter msg1-FDM in 2^{nd} set of {msg1-FrequencyStart, msg1-FDM}) are numbered/indexed in increasing order, starting from the lowest frequency (indicated by msg1-FrequencyStart in the 2^{nd} set). Alternatively, in some embodiments, this index/number of FDMed PRACH transmission occasions is also referred as f_id. In some embodiments, if the start index is not signaled/received in the random access resource configuration, then M equals the parameter msg1-FDM in the 1^{st} set of {msg1-FrequencyStart, msg1-FDM}.

In some embodiments, msg1-FrequencyStart in the 2^{nd} set indicates the PRB which is higher than the highest PRB of all FDMed PRACH occasions of the 1^{st} set.

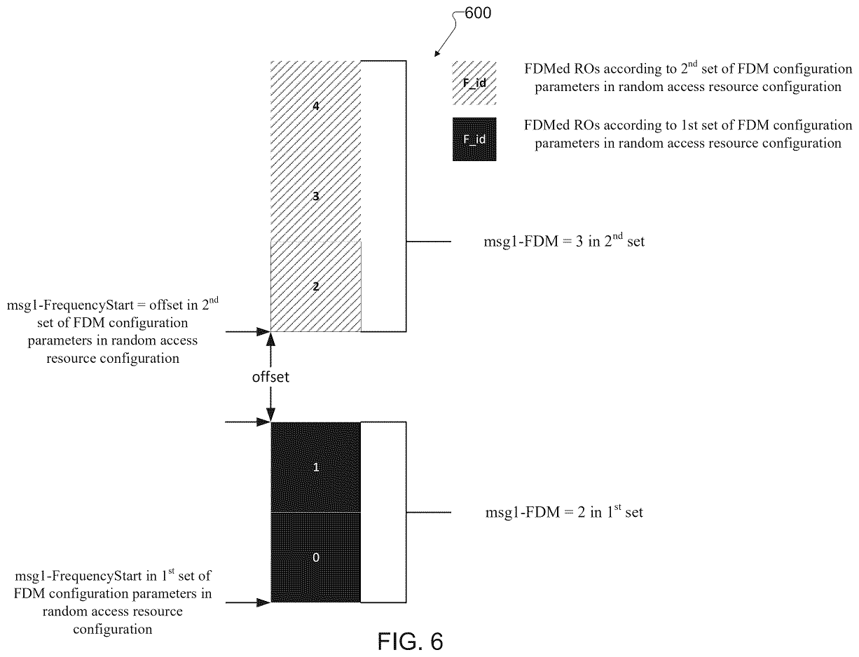

In some embodiments, if the 1^{st} set of parameters {msg1-FrequencyStart, msg1-FDM} is received in a random access resource configuration, msg1-FrequencyStart in the 2^{nd} set of parameters {msg1-Frequency Start, msg1-FDM} is the offset of the lowest PRACH transmission occasion in the frequency domain with respect to the highest PRB of FDMed PRACH occasions of the 1^{st} set, similar as shown in FIG. 6. Otherwise (i.e. if the 1^{st} set of parameters {msg1-FrequencyStart, msg1-FDM} is not received in a random access resource configuration), msg1-FrequencyStart in the 2^{nd} set of {msg1-FrequencyStart, msg1-FDM} is the offset of the lowest PRACH transmission occasion in the frequency domain with respect to PRB 0. In some embodiments, msg1-FrequencyStart in the 2^{nd} set of parameters {msg1-FrequencyStart, msg1-FDM} is the offset of the lowest PRACH transmission occasion in the frequency domain with respect to PRB 0.

FIG. 6 illustrates another example of indexing PRACH transmission occasions of additional RACH occasions 600 in a random access resource configuration according to embodiments of the present disclosure. The embodiment of indexing PRACH transmission occasions of additional RACH occasions of FIG. 6 is for illustration only. Different embodiments of indexing PRACH transmission occasions of additional RACH occasions could be used without departing from the scope of this disclosure.

In some embodiments, a UE (such as UE 116 of FIG. 1) may receive a random access resource configuration from a gNB (such as gNB 102 of FIG. 1) in system information or RRC message. The random access resource configuration can include 1^{st} and/or 2^{nd} set of parameters {msg1-FrequencyStart, msg1-FDM} as shown in FIG. 6. The 1^{st} set of parameters {msg1-FrequencyStart, msg1-FDM} indicates FDMed PRACH transmission occasions for a 1^{st} set of PRACH resources. These PRACH resources may not be dynamically activated/deactivated. The 2^{nd} set of parameters {msg1-FrequencyStart, msg1-FDM} indicates FDMed PRACH transmission occasions for additional PRACH resources (a 2^{nd} set of PRACH resources) which are dynamically activated/deactivated.

In the example of FIG. 6, msg1-FrequencyStart in the 2^{nd} set of parameters {msg1-FrequencyStart, msg1-FDM} is the offset of the lowest PRACH transmission occasion in the frequency domain with respect to the highest PRB of FDMed PRACH occasions of the 1^{st} set.

Although FIG. 6 illustrates one example of indexing PRACH transmission occasions of additional RACH occasions 600, various changes may be made to FIG. 6. For example, various changes to number of PRACH transmission occasions could be made, etc. according to particular needs.

Alternatively, in some embodiments, msg1-FrequencyStart in the 2^{nd} set of {msg1-FrequencyStart, msg1-FDM} is the offset of lowest PRACH transmission occasion in the frequency domain with respect to PRB 0.

In some embodiments, a random access resource configuration for 4 step RA can be configured by a RACH-ConfigCommon IE. The RACH-ConfigGeneric IE in the RACH-ConfigCommon IE can include a 1^{st} and/or 2^{nd} set of parameters {msg1-Frequency Start, msg1-FDM}. The RACH-ConfigGeneric IE in the RACH-ConfigCommon IE can include a 1^{st} and/or 2^{nd} set of parameters {PRACH configuration index}.

In some embodiment, a random access resource configuration for 2 step RA can be configured by a RACH-ConfigCommonTwoStepRA IE. The RACH-ConfigGenericTwoStepRA IE in the RACH-ConfigCommonTwoStepRA IE can include a 1^{st} and/or 2^{nd} set of parameters {msg1-FrequencyStart, msg1-FDM}. The RACH-ConfigGenericTwoStepRA in the RACH-ConfigCommonTwoStepRA IE can include a 1^{st} and/or 2^{nd} set of parameters {PRACH configuration index}.

In some embodiments, in the case of a random access resource configuration for 2 step RA, operations described herein can be applied, where a msg1-FDM can be named as msgA-RO-FDM, msg1-Frequency Start can be named as msgA-RO-Frequency Start, and PRACH configuration index can be named as msgA-PRACH-ConfigurationIndex in the operations described herein.

In some embodiments, a UE can select an RO from configured ROs of a 1^{st} set and/or 2^{nd} set and transmit a PRACH preamble the selected RO. In embodiment such as these, the UE can then monitor a PDCCH addressed to an RA-RNTI, wherein the RA-RNTI is calculated as follows: RA-RNTI=1+s_id+14*t_id+14*80*f_id+14*80*8*ul_carrier_id, where s_id is the index of the first OFDM symbol of the PRACH occasion (0≤s_id<14), t_id is the index of the first slot of the PRACH occasion in a system frame (0≤t_id<80), where the subcarrier spacing to determine t_id is based on the value of μ for μ={0, 1, 2, 3}, and for μ={5, 6}, t_id is the index of the 120 kHz slot in a system frame that contains the PRACH occasion (0≤t_id<80), f_id is the index of the PRACH occasion in the frequency domain (0≤f_id<8), and ul_carrier_id is the UL carrier used for Random Access Preamble transmission (0 for NUL carrier, and 1 for SUL carrier).

In some embodiments, in the case of 2 step RA, a UE can select an RO from configured ROs of a 1^{st} set and/or 2^{nd} set and transmit a PRACH preamble in the selected RO. In embodiments such as these, the UE can select a PUSCH occasion and transmit a MsgA MAC PDU. After transmitting the MsgA, the UE monitors PDCCH addressed to MSGB-RNTI wherein MSGB-RNTI is calculated as MSGB-RNTI=1+s_id+14×t_id+14×80×f_id+14×80×8×ul_carrier_id+14×80×8×2 where s_id is the index of the first OFDM symbol of the PRACH occasion (0≤s_id<14), t_id is the index of the first slot of the PRACH occasion in a system frame (0≤t_id<80), where the subcarrier spacing to determine t_id is based on the value of for μ={0, 1, 2, 3}, and for μ={5, 6}, t_id is the index of the 120 kHz slot in a system frame that contains the PRACH occasion (0≤t_id<80), f_id is the index of the PRACH occasion in the frequency domain (0≤f_id<8), and ul_carrier_id is the UL carrier used for Random Access Preamble transmission (0 for NUL carrier, and 1 for SUL carrier).

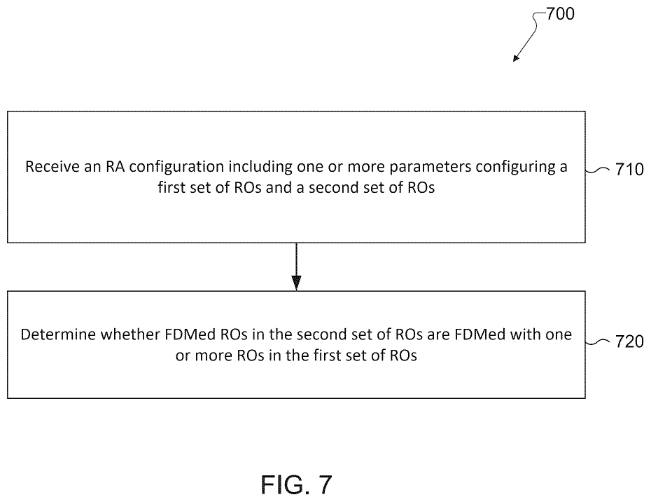

FIG. 7 illustrates an example method of FDMing of ROs 700 according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a method of FDMing of ROs could be used without departing from the scope of this disclosure.

In the example of FIG. 7, the method 700 begins at step 710. At step 710, a UE (such as UE 116 of FIG. 1) receives (for example, from a gNB such as gNB 102 of FIG. 1) an RA configuration. The RA configuration includes one or more parameters configuring a first set of ROs and a second set of ROs. For example, in some embodiments, the RA configuration may include a first message 1 frequency start (msg1-Frequency Start) parameter, a first message 1 FDMed (msg1-FDM) parameter, and a first RACH configuration index (prach-ConfigurationIndex) parameter for configuring the first set of ROs. In some embodiments, the RA configuration may include a second message 1 frequency start (msg1-Frequency Start) parameter, a second message 1 FDMed (msg1-FDM) parameter, and a second RACH configuration index (prach-ConfigurationIndex) parameter for configuring the second set of ROs.

At step 720, the UE determines whether FDMed ROs in the second set of ROs are FDMed with one or more ROs in the first set of ROs.

In some embodiments, when FDMed ROs in the second set of ROs are FDMed with one or more ROs in the first set of ROs, the FDMed ROs in the second set of ROs FDMed with the one or more ROs in the first set of ROs may be sequentially indexed in increasing order of frequency with an index starting from a value of a parameter in the RA configuration indicating a number of ROs FDMed in one time instance in the first set of ROs.

In some embodiments, when FDMed ROs in the second set of ROs are not FDMed with one or more ROs in the first set of ROs, the FDMed ROs in the second set of ROs may be sequentially indexed in increasing order of frequency with an index starting from zero.

In some embodiments, when FDMed ROs in the second set of ROs are FDMed with one or more ROs in the first set of ROs, the FDMed ROs in the first set of ROs may be sequentially indexed in increasing order of frequency with an index starting from zero.

In some embodiments, the second set of ROs may be dynamically activated.

In some embodiments, the second set of ROs may be dynamically deactivated.

Although FIG. 7 illustrates one example method of FDMing of ROs 700, various changes may be made to FIG. 7. For example, while shown as a series of steps, various steps in FIG. 7 could overlap, occur in parallel, occur in a different order, occur any number of times, be omitted, or replaced by other steps.

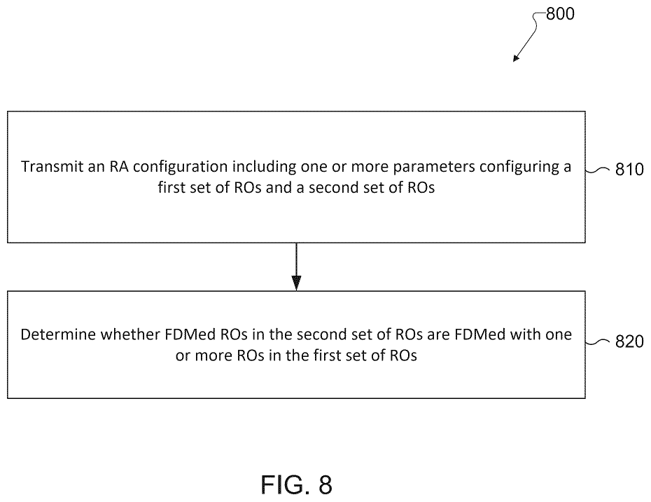

FIG. 8 illustrates another example method of FDMing of ROs 800 according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a method of FDMing of ROs could be used without departing from the scope of this disclosure.

In the example of FIG. 8, the method 800 begins at step 810. At step 810, a BS (such as gNB 102 of FIG. 1) transmits (for example, to a UE such as UE 116 of FIG. 1) an RA configuration. The RA configuration includes one or more parameters configuring a first set of ROs and a second set of ROs. For example, in some embodiments, the RA configuration may include a first message 1 frequency start (msg1-Frequency Start) parameter, a first message 1 FDMed (msg1-FDM) parameter, and a first RACH configuration index (prach-ConfigurationIndex) parameter for configuring the first set of ROs. In some embodiments, the RA configuration may include a second message 1 frequency start (msg1-Frequency Start) parameter, a second message 1 FDMed (msg1-FDM) parameter, and a second RACH configuration index (prach-ConfigurationIndex) parameter for configuring the second set of ROs.

At step 820, the BS determines whether FDMed ROs in the second set of ROs are FDMed with one or more ROs in the first set of ROs.

In some embodiments, when FDMed ROs in the second set of ROs are FDMed with one or more ROs in the first set of ROs, the FDMed ROs in the second set of ROs FDMed with the one or more ROs in the first set of ROs may be sequentially indexed in increasing order of frequency with an index starting from a value of a parameter in the RA configuration indicating a number of ROs FDMed in one time instance in the first set of ROs.

In some embodiments, when FDMed ROs in the second set of ROs are not FDMed with one or more ROs in the first set of ROs, the FDMed ROs in the second set of ROs may be sequentially indexed in increasing order of frequency with an index starting from zero.

In some embodiments, when FDMed ROs in the second set of ROs are FDMed with one or more ROs in the first set of ROs, the FDMed ROs in the first set of ROs may be sequentially indexed in increasing order of frequency with an index starting from zero.

In some embodiments, the second set of ROs may be dynamically activated.

In some embodiments, the second set of ROs may be dynamically deactivated.

Although FIG. 8 illustrates one example method of FDMing of ROs 800, various changes may be made to FIG. 8. For example, while shown as a series of steps, various steps in FIG. 8 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method of operating a user equipment (UE), the method comprising:
receiving a random access (RA) configuration including one or more parameters configuring a first set of random access channel (RACH) occasions (ROs) and a second set of ROs; and
determining whether frequency division multiplexed (FDMed) ROs in the second set of ROs are FDMed with one or more ROs in the first set of ROs,
wherein, when FDMed ROs in the second set of ROs are FDMed with one or more ROs in the first set of ROs, the FDMed ROs in the second set of ROs FDMed with the one or more ROs in the first set of ROs are sequentially indexed in increasing order of frequency with an index starting from a value of a parameter in the RA configuration indicating a number of ROs FDMed in one time instance in the first set of ROs.

2. The method of claim 1, wherein when FDMed ROs in the second set of ROs are not FDMed with one or more ROs in the first set of ROs, the FDMed ROs in the second set of ROs are sequentially indexed in increasing order of frequency with an index starting from zero.

3. The method of claim 1, wherein, the ROs in the first set of ROs are sequentially indexed in increasing order of frequency with an index starting from zero.

4. The method of claim 1, wherein the RA configuration includes a first message 1 frequency start (msg1-Frequency Start) parameter, a first message 1 FDMed (msg1-FDM) parameter, and a first RACH configuration index (prach-ConfigurationIndex) parameter for configuring the first set of ROs.

5. The method of claim 1, wherein the RA configuration includes a second message 1 frequency start (msg1-Frequency Start) parameter, a second message 1 FDMed (msg1-FDM) parameter, and a second RACH configuration index (prach-ConfigurationIndex) parameter for configuring the second set of ROs.

6. The method of claim 1, wherein the second set of ROs is dynamically activated.

7. The method of claim 1, wherein the second set of ROs is dynamically deactivated.

8. A method of operating a base station (BS), the method comprising:
transmitting a random access (RA) configuration including one or more parameters configuring a first set of random access channel (RACH) occasions (ROs) and a second set of ROs; and
determining whether frequency division multiplexed (FDMed) ROs in the second set of ROs are FDMed with one or more ROs in the first set of ROs,
wherein, when FDMed ROs in the second set of ROs are FDMed with one or more ROs in the first set of ROs, the FDMed ROs in the second set of ROs FDMed with the one or more ROs in the first set of ROs are sequentially indexed in increasing order of frequency with an index starting from a value of a parameter in the RA configuration indicating a number of ROs FDMed in one time instance in the first set of ROs.

9. The method of claim 8, wherein when FDMed ROs in the second set of ROs are not FDMed with one or more ROs in the first set of ROs, the FDMed ROs in the second set of ROs are sequentially indexed in increasing order of frequency with an index starting from zero.

10. The method of claim 8, wherein, when FDMed ROs in the second set of ROs are FDMed with one or more ROs in the first set of ROs, the FDMed ROs in the first set of ROs are sequentially indexed in increasing order of frequency with an index starting from zero.

11. The method of claim 8, wherein the RA configuration includes a first message 1 frequency start (msg1-Frequency Start) parameter, a first message 1 FDMed (msg1-FDM) parameter, and a first RACH configuration index (prach-ConfigurationIndex) parameter for configuring the first set of ROs.

12. The method of claim 8, wherein the RA configuration includes a second message 1 frequency start (msg1-Frequency Start) parameter, a second message 1 FDMed (msg1-FDM) parameter, and a second RACH configuration index (prach-ConfigurationIndex) parameter for configuring the second set of ROs.

13. The method of claim 8, wherein the second set of ROs is dynamically activated, and the second set of ROs is dynamically deactivated.

14. An electronic device comprising:
at least on processor including processing circuitry; and
memory storing instructions, wherein the instructions, when executed by the at least one processor individually or collectively, cause the electronic device to:
receive a random access (RA) configuration including one or more parameters configuring a first set of random access channel (RACH) occasions (ROs) and a second set of ROs; and
determine whether frequency division multiplexed (FDMed) ROs in the second set of ROs are FDMed with one or more ROs in the first set of ROs,
wherein, when FDMed ROs in the second set of ROs are FDMed with one or more ROs in the first set of ROs, the FDMed ROs in the second set of ROs FDMed with the one or more ROs in the first set of ROs are sequentially indexed in increasing order of frequency with an index starting from a value of a parameter in the RA configuration indicating a number of ROs FDMed in one time instance in the first set of ROs.

15. The electronic device of claim 14, wherein when FDMed ROs in the second set of ROs are not FDMed with one or more ROs in the first set of ROs, the FDMed ROs in the second set of ROs are sequentially indexed in increasing order of frequency with an index starting from zero.

16. The electronic device of claim 14, wherein the ROs in the first set of ROs are sequentially indexed in increasing order of frequency with an index starting from zero.

17. The electronic device of claim 14, wherein the RA configuration includes a first message 1 frequency start (msg1-Frequency Start) parameter, a first message 1 FDMed (msg1-FDM) parameter, and a first RACH configuration index (prach-ConfigurationIndex) parameter for configuring the first set of ROs.

18. The electronic device of claim 14, wherein the RA configuration includes a second message 1 frequency start (msg1-Frequency Start) parameter, a second message 1 FDMed (msg1-FDM) parameter, and a second RACH configuration index (prach-ConfigurationIndex) parameter for configuring the second set of ROs.

19. The electronic device of claim 14, wherein the second set of ROs is dynamically activated.

20. The electronic device of claim 14, wherein the second set of ROs is dynamically deactivated.
